(19) United States
(12) Patent Application Publication
(10) Pub. No.: US 2018/0001322 A1
(43) Pub. Date: Jan. 4, 2018

(54) PAPER SHREDDER WITH JAM CLEARING

(71) Applicant: AURORA OFFICE EQUIPMENT CO., LTD. SHANGHAI, Shanghai (CN)

(72) Inventors: YANLU CHANG, Shanghai (CN); KAIPING LI, Shanghai (CN)

(73) Assignee: AURORA OFFICE EQUIPMENT CO., LTD. SHANGHAI, Shanghai (CN)

(21) Appl. No.: 15/237,436

(22) Filed: Aug. 15, 2016

(30) Foreign Application Priority Data
Jun. 29, 2016 (CN) 201610493218.4

(51) Int. Cl. B02C 18/00; B02C 18/16; B02C 25/00

(52) U.S. Cl. CPC B02C 18/0007; B02C 25/00; B02C 18/16; B02C 2018/164; B02C 2018/0023

(57) ABSTRACT

A paper shredder jam clear mechanism including a power switch coupled to bidirectional motor, a sensor coupled to the power switch, and disposed in a feed inlet, and a jam clear button coupled to the sensor. The power switch has an AUTO/FORWARD position, to move the motor forward; an OFF position; and a REVERSE position, to move the motor in reverse. The sensor is coupled to the power switch in the AUTO/FORWARD position, and the motor is moved forward when the sensor detects an object in the feed inlet. The jam clear switch is configured to contact the sensor, and to move the motor forward. A delay circuit is coupled to the contact switch and to the motor, when actuated by the contact switch delays an operation of the motor for a period. Also, the delay circuit when actuated causes a brief period of auto-operation operation of the motor.

### CROSS-REFERENCE TO RELATED APPLICATION

This application claims foreign priority to CN201610493218.4 filed on Jun. 29, 2016, which is hereby incorporated by reference in its entirety.

### BACKGROUND

### 1. Field of the Invention

This invention applies to paper shredders and, more particularly to a paper shredder with a paper jam clearing mechanism.

### 2. Background Technology

A paper shredder is a beneficial piece of machinery, used in the home, or in the office. A paper shredder can include a head and a waste bin to receive the header. The head includes a motor coupled to a power switch, which is coupled to a power supply. The motor is mechanically coupled to a set of shredder blades, which generally are positioned beneath a paper inlet. Typically, a paper shredder operates by accepting one or more sheets of paper in the paper inlet, sensing the inserted paper, and operating a motor, which causes shredder blades to slice the received paper into shreds of paper. Once the shredder blades are free of received paper, turning off the motor, which stops the shredder blades. A paper shredder can be rated to shred a selected number of paper sheets with a certain thickness, for optimum efficiency. Also, it is desirable for the paper sheets to be fed straight into the paper inlet. Unfortunately, at times, a user might insert too many sheets of paper, or insert the paper at an angle to the paper inlet. Although the shredder may attempt to shred the inserted paper, the motor may stall because the shredder blades are overloaded. This situation is called a paper jam. Paper jams also may be caused, for example, by attempting to shred a sheet that is too thick, or by attempting to shred the wrong type of material (e.g., a thick plastic sheet). Removing the jam can be a cumbersome and potentially dangerous process, in which a user employs their fingers or a tool to clear the jam. What is needed is a jam clear mechanism on the shredder, which assists the user in clearing the jam and in returning the shredder to normal use.

### SUMMARY

The embodiments herein provide a paper shredder with a paper jam clearing mechanism. Embodiments herein provide a jam clear mechanism for a paper shredder with a feed inlet and shredder blades disposed adjacent to the feed inlet and a bidirectional motor coupled to the shredder blades, including a power switch coupled to the motor, a sensor coupled to the power switch and disposed in the feed inlet, and a jam clear button coupled to the sensor. In embodiments of the paper shredder, the power switch has an AUTO/FORWARD position, configured to motivate the motor in a forward direction; an OFF position, configured to maintain the motor in an OFF configuration; and a REVERSE position, configured to motivate the motor in a reverse direction. In embodiments, the sensor is coupled to the power switch in the AUTO/FORWARD position, and the motor is motivated in the forward direction when the sensor detects an object in the feed inlet. In embodiments, the jam clear switch is configured to contact the sensor, and the motor is motivated in the forward direction when the jam clear switch contacts the sensor. Also included can be a contact switch coupled to the sensor and the jam clear switch, wherein the contact switch when actuated causes the motor to be motivated in the forward direction. Embodiments can further include a delay circuit coupled to the contact switch and to the motor, wherein the delay circuit when actuated by the contact switch delays an operation of the motor for a predefined period. Also, the delay circuit when actuated by the contact switch causes a brief period of auto-operation operation of the motor.

### BRIEF DESCRIPTION OF THE DRAWINGS

The invention is generally shown by way of reference to the accompanying drawings in which:

FIG. 1 is an illustration of a shredder, in accordance with the teachings of the present invention;

FIG. 2 is an exploded view illustration of a jam clear switch, in accordance with the teachings of the present invention; and

FIG. 3 is a schematic diagram of a circuit for the shredder in FIG. 1, in accordance with the teachings of the present invention.

Some embodiments are described in detail with reference to the related drawings. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

### DETAILED DESCRIPTION OF THE EMBODIMENTS

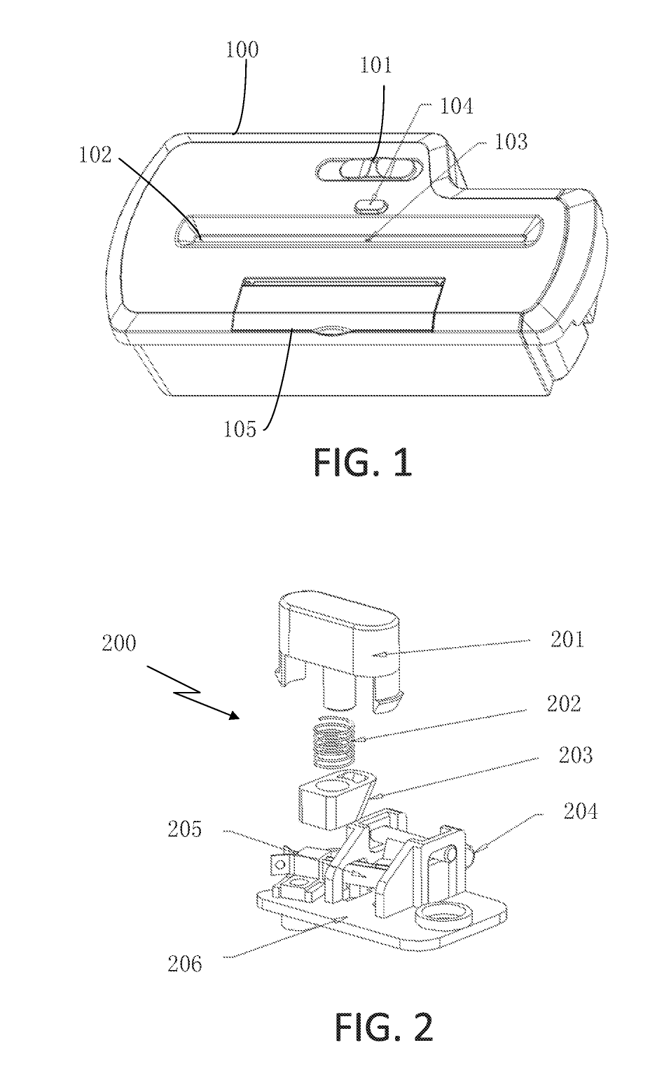

FIG. 1 illustrates shredder 100 having power switch 101 and a feed inlet 102. Power switch 101 can be a three position switch, with the power OFF when power switch 101 is centrally-positioned; AUTO/FORWARD when power switch 101 is placed in one position (e.g., to the left of the OFF position); and REVERSE when power switch 101 is placed in the other position (e.g., to the right of the OFF position). Power switch 101 is coupled between a power supply (e.g., 110 VAC) and a reversible motor (not shown). The reversible motor can be coupled to shredding blades (not shown), which can be located below feed inlet 102. In the OFF position, power is interrupted to the motor and the shredder cannot be operated. Sensor 103 can be coupled to power switch 101, such that when power switch 101 is in the AUTO/FORWARD position and sensor 103 detects the presence of paper in the feed inlet 102, the motor is energized in the forward direction, which rotates the shredding blades, drawing the paper down into feed inlet 102, and cutting the paper into shreds. Once shredding is complete, the motor stops but remains energized until additional paper is inserted into feed inlet 102. The motor can be momentarily operated when power switch 101 is initially set to the AUTO/FORWARD position from the OFF position, to verify shredder operability. After the brief period of operation the motor stops, and the shredder enters to Auto/Standby mode. When power switch 101 is placed in the REVERSE position, the motor turns in the reverse direction, the paper in the cutting blades is driven up and out of feed inlet 102. In some embodiments, the motor turns continuously in the reverse direction so long as power switch 101 is set in the REVERSE position. Placing power switch 101 into the REVERSE position can be one method of clearing a paper jam in the shredder. Embodiments of shredder 100 can include a jam clear switch 104, which can be formed as a manual push-button switch, although other switch configurations are possible. Jam clear switch 104 can operate in conjunction with power switch 101. When power switch 101 is in the AUTO/FORWARD position, jam clear switch 104 can be operated to cause the motor to operate in the forward direction so long as jam clear switch 104 is depressed. In selected embodiments, jam clear switch 104 can operate with a brief delay before the motor turning off. Auxiliary inlet cover 105 is disposed over an auxiliary feed inlet (not shown), which when opened, exposes the auxiliary feed inlet and enables a user to shred a CD or DVD disc by depressing jam clear switch 104 until the CD/DVD is consumed. Thus, jam clear switch 104 can be a dual-purpose switch.

Jam clear button 200; Jam clear button cap 201; jam clear button reset spring 202, beveled block 203; paper feed block 204; contact switch 205; switch base 206.

FIG. 2 depicts jam clear switch 200, which embodiment can be similar to switch 104. Jam clear button switch 200 can include jam clear button cap 201, which is coilingly supported on beveled block 203 by jam clear button spring 202. Jam clear button spring 202 is configured to expand, thus, when jam clear button cap 201 is depressed, spring 202 can exert a counterforce leading to cap 201 being restored to its initial position after release. Paper feed block 204 can be a mechanical arm which can protrude into paper feed inlet 102 and can act as sensor in paper feed inlet 102 to detect the presence of paper. In this embodiment, paper feed block 204 can be, or be similar to, sensor 103. Electrical contact switch 205 can be operated by depressing button 201 against switch base 206. Also, electrical contact switch 205 can be operated by placing paper on paper feed block 204 (e.g., sensor 103).

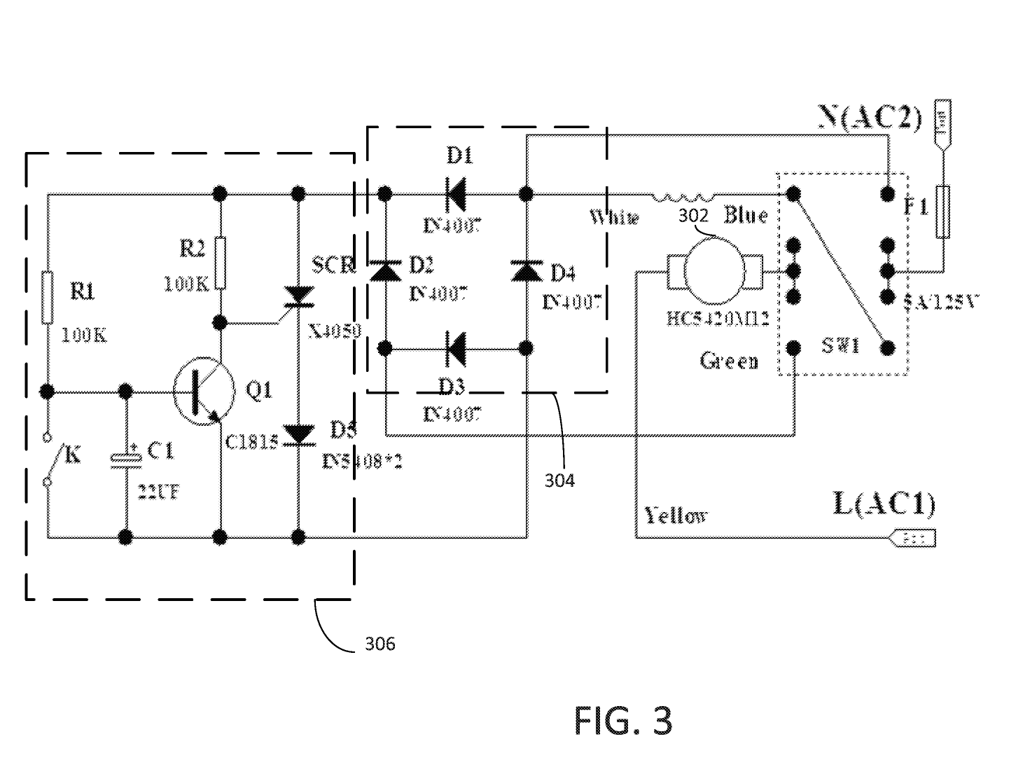

Turning to FIG. 3, delay circuit 300 can be illustrated. In embodiments herein, a delay may be used to provide a brief period of auto-operation after jam clear switch 104 has been operated, sufficient to clear the shredding blades of waste paper. A brief period of auto-operation also can be provided after paper fed into feed inlet 102 has passed paper sensor 103. To that end, switch K in FIG. 3 can be like electrical contact switch 205, in FIG. 2. For selected embodiments, a reversible motor 302 can be used. A suitable motor 302 can be a model HC5420M12, a 125V 5A single-phase AC electric universal motor available from, for example, Shenzhen Odin Import and Export Co, LTD., Shenzhen, CN. AC power, when provided to motor 302 via switch SW1, can be available to the terminals of rectifier bridge 304, D1-D4, converting the AC power input into a DC output to the delay circuit 306. The delay circuit 306 can consist of K, R1, C1, R2, Q1, SCR, and D5, as is illustrated in FIG. 3. When switch K is closed, capacitor C1 charges, and power is applied to motor 302. After this, when switch K is opened, the charge stored in capacitor C1 continues to operate motor 302 until capacitor C1 is discharged.

While embodiments have been described in detail, it should be appreciated that various modifications and/or variations may be made without departing from the scope or spirit of the invention. In this regard it is important to note that practicing the invention is not limited to the applications described herein above. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein above. Thus, it is intended that the invention cover all such embodiments and variations. Nothing in this disclosure is intended to limit the scope of the invention in any way.

What is claimed is:

1. A paper shredder with a feed inlet and shredder blades disposed adjacent to the feed inlet and a bidirectional motor coupled to the shredder blades, comprising:
a power switch coupled to the motor;
a sensor coupled to the power switch and disposed in the feed inlet; and
a jam clear button coupled to the sensor.

2. The paper shredder of claim 1, further comprising:
the power switch has an AUTO/FORWARD position, configured to motivate the motor in a forward direction; an OFF position, configured to maintain the motor in an OFF configuration; and a REVERSE position, configured to motivate the motor in a reverse direction.

3. The paper shredder of claim 2, wherein the sensor is coupled to the power switch in the AUTO/FORWARD position, and the motor is motivated in the forward direction when the sensor detects an object in the feed inlet.

4. The paper shredder of claim 3, wherein the jam clear switch is configured to contact the sensor, and the motor is motivated in the forward direction when the jam clear switch contacts the sensor.

5. The paper shredder of claim 1, further comprising:
a contact switch coupled to the sensor and the jam clear switch, wherein the contact switch when actuated causes the motor to be motivated in the forward direction.

6. The paper shredder of claim 4, further comprising:
a contact switch coupled to the sensor and the jam clear switch, wherein the contact switch when actuated causes the motor to be motivated in the forward direction.

7. The paper shredder of claim 5, further comprising a delay circuit coupled to the contact switch and to the motor, wherein the delay circuit when actuated by the contact switch delays an operation of the motor for a predefined period.

8. The paper shredder of claim 6, further comprising a delay circuit coupled to the contact switch and to the motor, wherein the delay circuit when actuated by the contact switch delays an OFF operation of the motor.

9. The paper shredder of claim 8, wherein the delay circuit when actuated by the contact switch causes a predetermined period of auto-operation operation of the motor.
